(19) United States
(12) Patent Application Publication
(10) Pub. No.: US 2003/0074583 A1
(43) Pub. Date: Apr. 17, 2003

(54) Network resource access

(76) Inventors: Millard Jay Habegger, Scituate, MA (US); Michael Paul Keohane, Brighton, MA (US); Richard Joseph Thornett, Newtonville, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/138,208

(22) Filed: May 3, 2002

Related U.S. Application Data
(60) Provisional application No. 60/288,594, filed on May 3, 2001.

(51) Int. Cl. G06F 11/30

(52) U.S. Cl. 713/201; 709/229

(57) ABSTRACT

In general, in one aspect, the disclosure describes a method for use in providing access to network resources. The method includes receiving, at a first server from a remote client, a message identifying a network resource. The method also includes determining authorization information associated with the user or the group and sending the authorization information, in accordance with the authorization scheme, to the second server.

### REFERENCE TO RELATED APPLICATIONS

This application claims priority to co-pending U.S. Provisional Application Serial No. 60/288,594, filed on May 3, 2001, entitled “SYSTEMS AND METHODS FOR SEAMLESS INTERNET ACCOUNT ACCESS”. This application is incorporated by reference in its entirety herein.

### BACKGROUND

Networks, such as the Internet, provide users access to a wide variety of resources. These resources include documents, such as analyst reports and technical white papers, and other electronic content, such as audio and video.

In technical terms, these resources are provided by network servers. Servers receive requests for resources from clients and send the requested resource in response. Often network servers protect resources from unauthorized access. For example, many servers require a user to correctly enter a username and password before authorizing access. A username/password scheme is one of a variety of authentication mechanisms that enables a server to restrict access to particular users.

Different servers may use different authorization schemes. Additionally, even those servers that use the same kind of authorization scheme may request different information from a user. For example, a user's username and password may be different for different servers. Thus, as a user “surfs” to different network servers, the user often needs to remember and re-enter their authorization data.

### SUMMARY

In general, in one aspect, the disclosure describes a method for use in providing access to network resources. The method includes receiving, at a first server from a remote client, a message identifying a network resource, the message being associated with a user or group, the resource being protected by an authorization scheme provided by a second server. The method further includes determining authorization information associated with the user or the group and sending the authorization information, in accordance with the authorization scheme, to the second server.

Embodiments may include one or more of the following features. The method may include transmitting instructions for processing by the client that cause the client to transmit the authorization information to the second server. The method may also include determining that the authorization information sent to the second server by the first server results in authorization. The instructions may be in JavaScript. The authorization information associated with the user may include a username and a password for the authorization scheme provided by the second server. The method may include storing authorization information for different users. The method may include determining the authorization scheme provided by the second computer. The method may include storing information identifying the different authorization schemes provided by different respective servers. The method may include sending the information to the second server within an HTTP (HyperText Transfer Protocol) GET or POST message. The network may be an intranet or the Internet. The network resource may be a document. The method may include sending an abstract of the network resource to the client. The message identifying a network resource may be a message generated in response to user selection of the abstract.

In general, in another aspect, the disclosure describes a computer program product, disposed on a computer readable medium, for use in providing access to network resources. The program includes instructions for causing a processor to receive, at a first server from a remote client, a message identifying a network resource, the message being associated with a user or group, the resource being protected by an authorization scheme provided by a second server. The program also includes instructions that determine authorization information associated with the user or the group of users and send the authorization information, in accordance with the authorization scheme, to the second server.

In general, in another aspect, the disclosure describes a method for authorizing a user attempting to access a document over the Internet. The method includes storing authorization information for different users, storing information identifying the different authorization schemes used by different respective servers, sending an abstract of a document to a web browser client, receiving, at a first server from the web browser client, a message identifying the document, the message being associated with the user, the document being protected by an authorization scheme provided by a second server, determining authorization information associated with the user, the authorization information including a username and a password, determining the authorization scheme provided by the second server, sending the authorization information, in accordance with the authentication scheme, to the second server, determining that the authorization information sent to the second server successfully authorized access, and transmitting instructions to the client, the instructions for causing the client to transmit the authorization information to the second server.

In general, in another aspect, the disclosure describes a system for providing access to network resources served by different network servers. The system includes storage configured to store authorization information for different servers and/or resources for different users and/or groups of users. The system also includes instructions for causing a system processor to receive, at a first server from a remote client, a message identifying a network resource, the message being associated with a user or group of users, the resource being protected by an authorization scheme provided by a second server. The instructions also cause the processor to determine authorization information associated with the user or the group of users from the storage of authorization information, and send the authorization information, in accordance with the authorization scheme, to the second server.

In general, in another aspect, the disclosure describes a method for use in providing access to network resources. The method includes receiving, at a first server from a remote client, a message identifying a network resource, the message being associated with a user or group of users, the resource being protected by an authorization scheme provided by a second server. The method also includes determining authorization information associated with the user or the group of users, and transmitting instructions for processing by the client, the instructions for causing the client to transmit the authorization information to the second server.

### BRIEF DESCRIPTION OF THE DRAWINGS

FIGS. 1 to 10 are diagrams that illustrate operation of a system for providing access to network resources.

FIG. 11 is a diagram of a system for use in providing access to network resources.

FIG. 12 is a flow-chart of a process for use in providing access to network resources.

### DETAILED DESCRIPTION

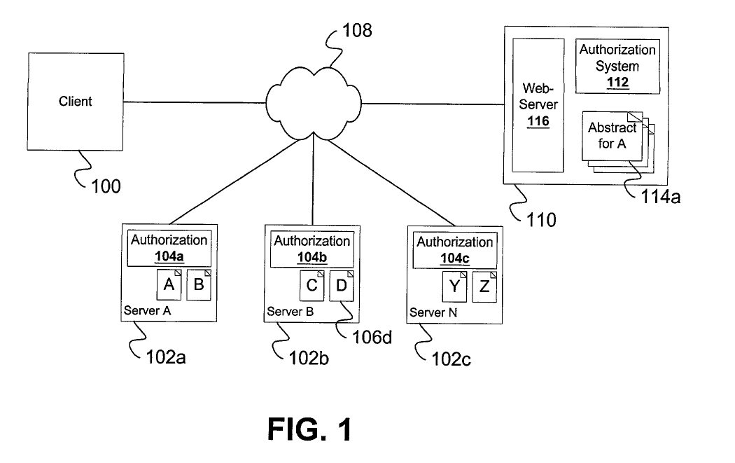

FIGS. 1 depicts resources 106 stored on different network servers 102. As shown, the servers 102 protect the resources 106 from unauthorized access using authorization schemes 104. These authorization schemes 104 may vary in the techniques they use to authorize access to the resources 106 and may also vary in the data they collect to provide authorization.

Described herein is an approach that takes care of server authorization for a user “behind the scenes”. In this scheme, a server 110 can automatically handle aspects of authorization on behalf of a user. This can potentially free the user to access resources 106 provided by different servers 110 without repeatedly entering their authorization data into server forms. The server 110 can support many different servers 102 providing resources and can support many different users.

In greater detail, FIG. 1 shows a client 100 connected to a network 108. The client 100 may be a browser (e.g., Microsoft Explorer) that sends requests for network resources 106 provided by different Internet or intranet servers 102. These requests may be HTTP (HyperText Transfer Protocol) messages that identify a resource 106 using a URL (Universal Resource Locator). For example, a request for a document from the New York Times web server may be “HTTP GET www.nytimes.com/headlines.html” where the string “www.nytimes.com/headlines.html” is the URL specifying the desired resource.

FIG. 1 also shows a server 110 that can coordinate access to the server' 102 resources 106. The server 110 includes a web server 116 (e.g., an Apache web server) that responds to received HTTP messages. The server 110 also includes authorization instructions 112 that can negotiate authorization with different servers 102 for a user operating a client loo.

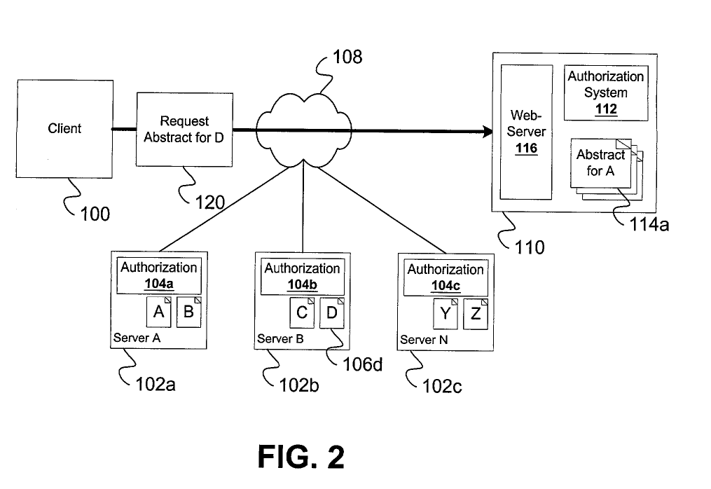

To illustrate how the approach can be used to provide client 100 access to resources 106, FIGS. 2-10 depict an example of operation of an authorization system. In this example, server 110 performs a “test” negotiation of authorization with a server 102 protecting a resource 102 of interest to a user. This test can determine whether the user is authorized to access the requested resource. After this test, the server 110 can transmit information to the client 100 so that the client 100 can repeat the authorization negotiation and establish an independent session with the server 102. This approach enables the server 110 to coordinate authorization without necessitating further involvement with a session that ensues between the client 100 and the server 104. This “handing off” of the session to the client 100, however, is merely optional. That is, server 110 may act as a proxy after initially negotiating authorization.

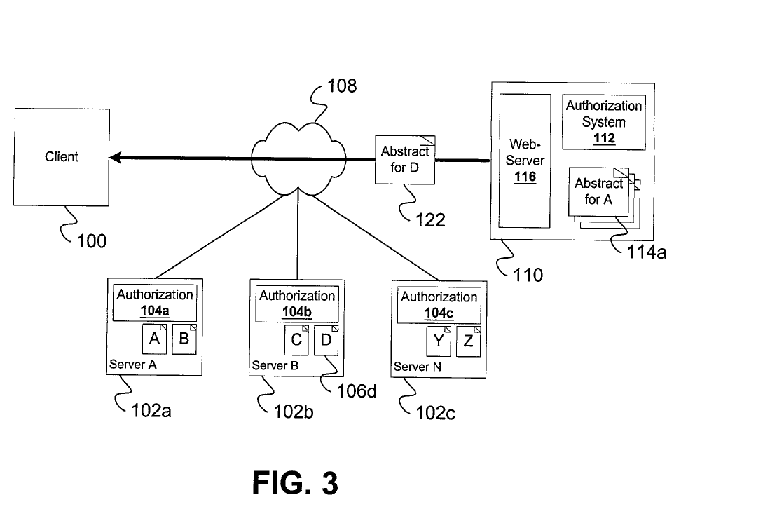

In the sample shown in FIG. 2, the server 110 stores abstracts 114 of resources 106. Such abstracts may include text descriptions of the resource 106 and/or other information (e.g., thumbnails of images or sound clips). The web server 116 may provide web pages that permit a user to specify a search of the abstracts and display a list of abstracts relevant to the query. For example, as shown in FIG. 2, a user operates the client 100 to request 120 an abstract 114 for a particular resource. As shown in FIG. 3, the server 110 responds by sending a message 122 to the client 100 that includes the abstract for presentation to the user.

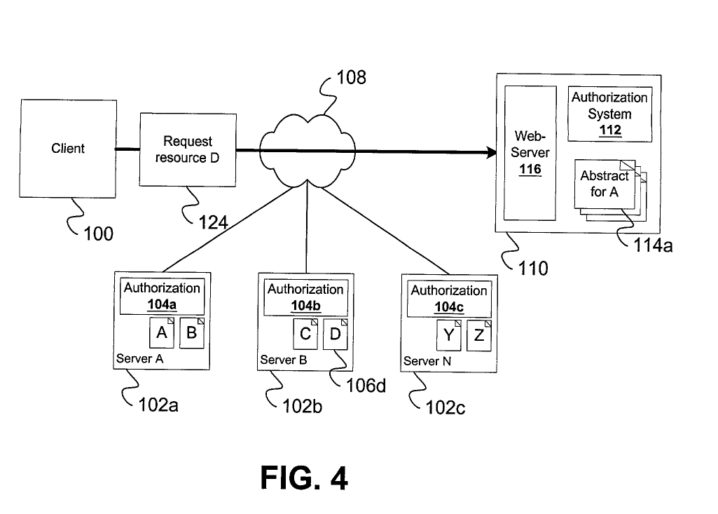

After viewing the abstract, the user may indicate they would like to receive the resource 106d described by the abstract. For example, a user may select a “View document” button displayed by a web page provided by the server 110. As shown, in FIG. 4, selection can cause the client 100 to send a request 124 for the resource to the server 110. Upon receipt of the request 124, the server 110 may determine the identity of a user if this has not been done previously. For example, the server 110 may interactively collect user information (e.g., username and password) via fields in a web page or non-interactively by collecting a “cookie” stored by client 100. This authorization process with server 110 can permit the server 110 to determine the authorization information associated with a particular user or group of users. Thereafter, the server 110 can provide authorization for resources 106 provided by servers 102 without further user participation in the authorization schemes 104 used by the servers 102.

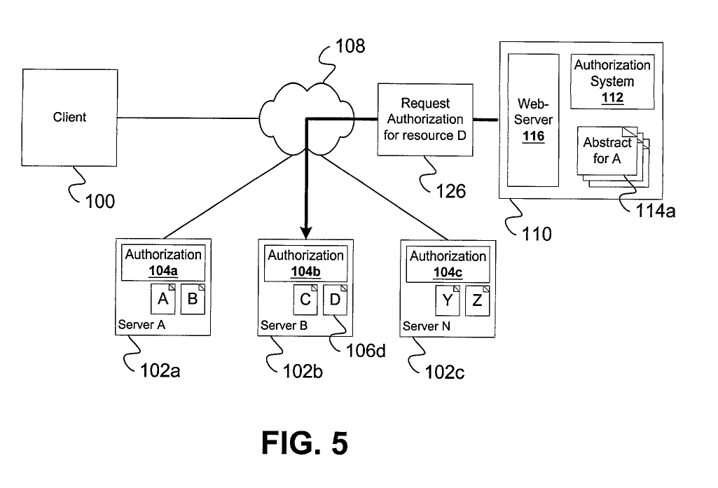

As shown in FIG. 5, the server 110 determines authorization information associated with the user that can be used to gain access to the resource. For example, the server 110 can determine the server 102b that provides the requested resource 106d (e.g., by parsing the request message 124 of FIG. 4) and lookup the user's username and password for the server 102b in a database. After retrieving the authorization information, the server 110 can negotiate authorization on behalf of the user by assembling the authorization information into a structure compliant with the authorization scheme provided by the server 102b storing the requested resource 106d. The server 110 can then transmit the assembled information in accordance with the server 102b authorization scheme(s) 104b. The transmitted information can simulate a form submission process. For example, an HTTP GET message assembled for transmission to the server 102b can include a request for a URL of “www.server.com/document.doc?username=guest; password=rosebud”. Other authorization schemes, however, will expect the authorization information to be encoded differently (e.g., as an HTTP POST message).

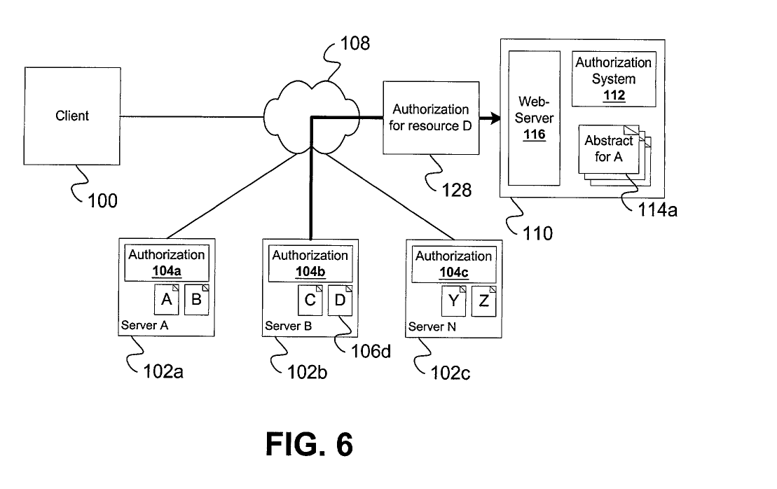

As shown in FIG. 6, the server 102b receiving the authorization information can return an indication 128 that authorization to access the resource has been granted. For example, such an indication may be as simple as an HTTP “OK” message. The server 110 can parse the received message 128 to determine whether or not the server 102b has authorized access.

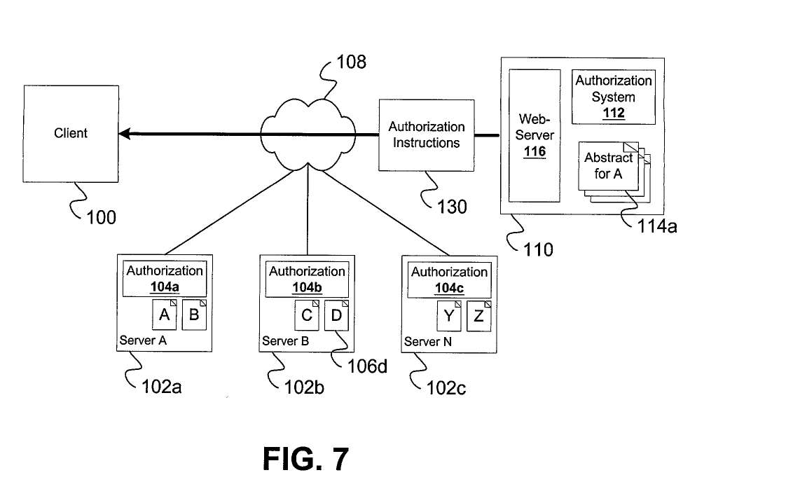

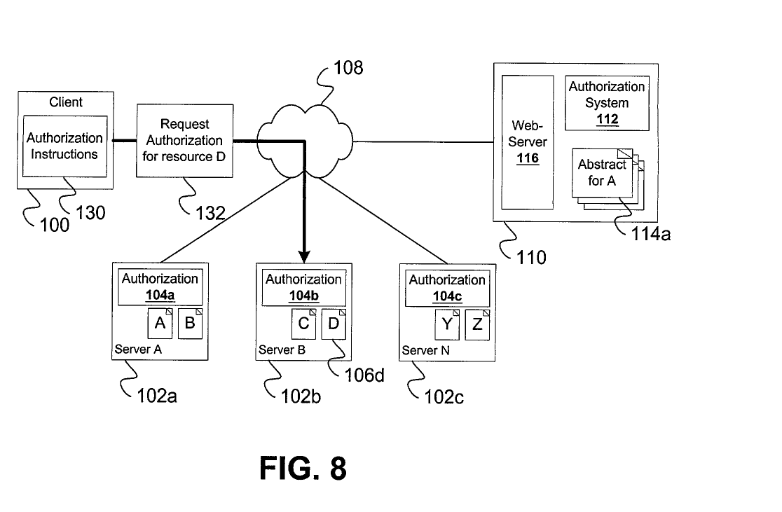

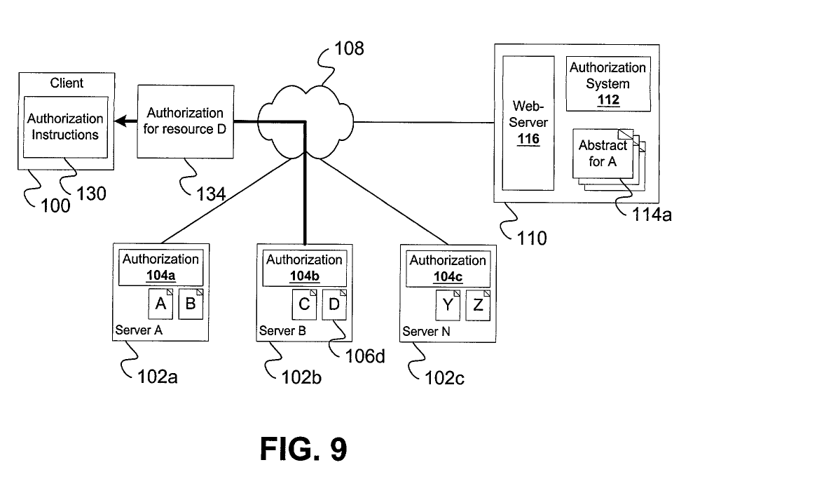

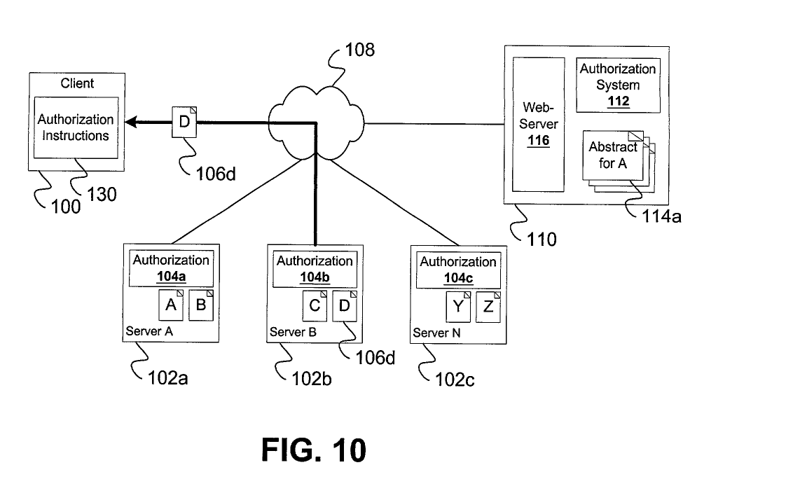

As shown in FIG. 7, after determining authorization has been granted, the server 110 can transmit information 130 to the client 100 that enables the client 100 to independently initiate a session with the server 104. For example, the server 110 may send the client 100 instructions (e.g., JavaScript) that the client 100 can interpret or execute to establish authorized access to the resource. The instructions can repeat the authorization negotiation successfully tested by the server 110. Thus, as shown, the client 100 sends a request 132 for authorization (FIG. 8), receives authorization 134 (FIG. 9), and ultimately receives the resource 106d of interest (FIG. 10).

Once a session is established between the client 100 and the server 102b providing the resource 106d, reauthorization need not be repeated unless required by the server 102b. That is, typically, a client 100 will establish a session only once with a server in a given time period even though the client 100 may access different resources 106 served by the server 102b.

FIGS. 2-10 depict sample operation of an example system. However, other systems need not proceed as described above. For example, the server 110 need not “test” authorization before sending the authorization instructions 130 to the client 100. Additionally, as described above, the server 110 need not transmit authorization instructions 130 at all, but may instead act as a “go between” between the client 100 and the server 102d protecting the resources 106d of interest after initially negotiating authorization.

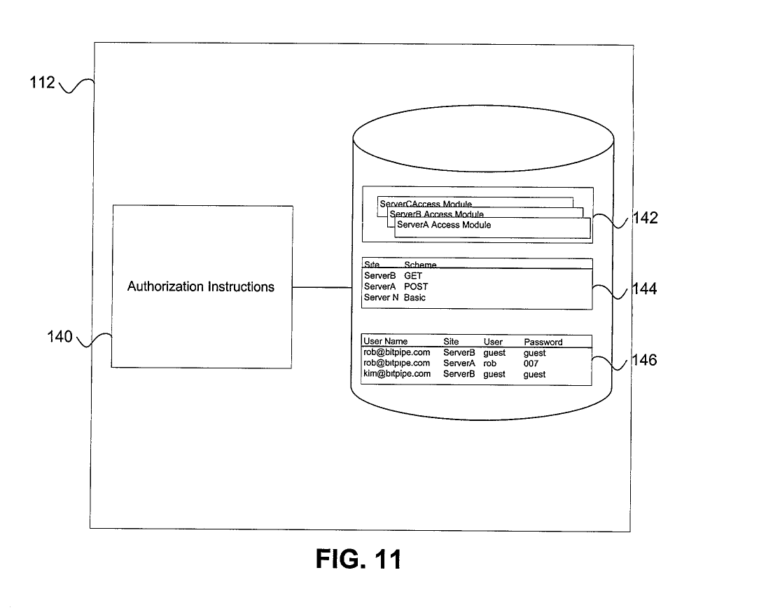

FIG. 11 depicts a sample architecture of an authorization system 112 (e.g., 112 in FIGS. 1-10). As shown the system 112 includes a database (e.g., a MySQL relational database) that stores authorization information 146 for different users at different servers. For example, as shown, a user “rob@bitpipe.com” can use a username of “Rob” and a password of “007” to access resources from ServerA and a username of “guest” and a password of “guest” to access resources from ServerB. After determining the server storing a requested resource, authorization instructions 140 can retrieve the appropriate authorization information for a user. The data 146 may include a username and password, as shown, and/or other credentials. The data 146 may include entries for different users or groups of users. By providing a “group” capability, a user can gain access to many different servers 102 without explicitly registering. That is, a new member of a group can access those servers 102 already having defined authorization information.

As shown, the database also includes data 144 identifying the authorization scheme used by a server. For example, as shown, ServerA uses an HTTP GET encoding scheme, ServerB uses an HTTP POST encoding scheme, while ServerC uses a technique known as Basic Authorization. By changing these entries, the server 110 can quickly adapt should a server change its authorization scheme.

The database also includes modules of instructions 142 that control how to negotiate authorization with the server storing a resource of interest. These instructions 142 can access and assemble authorization information and handle communication with the server storing a desired resource. For example, based on the type of authorization scheme 144 identified for a given server, the instructions 142 can negotiate access to a server using the user's authorization information 146. The system 112 can then package instructions for transmission to the client 100 so that the client can repeat the proven-successful negotiation.

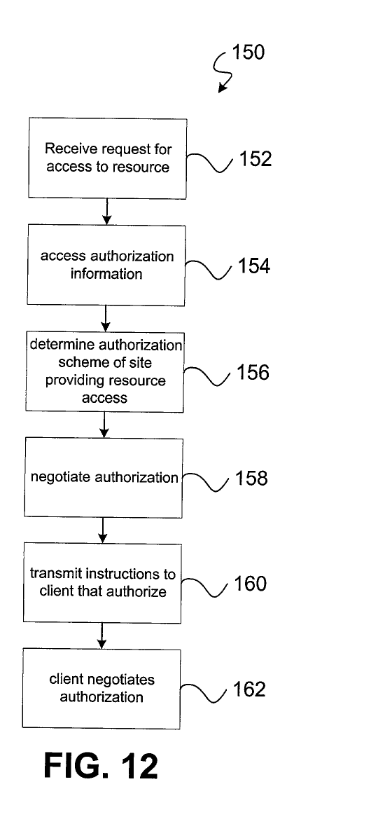

FIG. 12 depicts a flow-chart of the process 150 described above. As shown, after a server receives 152 a user request for access to a resource provided by a different server, the server retrieves 154 authorization information for the user (e.g., by retrieving data from data 146) and identifies 156 the type of authorization scheme used by the server providing the resource (e.g., by retrieving data from data 144). After successfully negotiating 158 authorization with the server, the process 150 transmits 160 instructions to the client that cause the client to negotiate authorization.

The above described a sample implementation. However, there are a wide variety of variations of the above. For example, while depicted as separate entities, the authorization instructions 112 may be integrated into the web server 116. Additionally, while the above describes a division between the access module instructions and the database of authorization schemes, other implementations may include different configurations. For example, the access modules may be hard-coded for the authorization scheme provided by a server 102.

The techniques described herein may find applicability in many computing or processing environments. The techniques may be implemented in hardware or software, or a combination of the two. Preferably, the techniques are implemented in computer programs executing on programmable computers that each include a processor, a storage medium readable by the processor (including volatile and non-volatile memory and/or storage elements), at least one input device, and one or more output devices.

Each program is preferably implemented in high level procedural or object oriented programming language to communicate with a computer system. However, the programs can be implemented in assembly or machine language, if desired. In any case the language may be compiled or interpreted language.

The computer program(s) are preferably stored on a storage medium or device (e.g., CD-ROM, hard disk, or magnetic disk) that is readable by a general or special purpose programmable computer for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner.

Other embodiments are within the scope of the following claims.

What is claimed is:

1. A method for use in providing access to network resources, the method comprising:
receiving, at a first server from a remote client, a message identifying a network resource, the message being associated with a user or group, the resource being protected by an authorization scheme provided by a second server;
determining authorization information associated with the user or the group; and
sending the authorization information, in accordance with the authorization scheme, to the second server.

2. The method of claim 1, further comprising transmitting instructions for processing by the client, the instructions for causing the client to transmit the authorization information to the second server.

3. The method of claim 2, further comprising determining that the authorization information sent to the second server by the first server results in authorization.

4. The method of claim 2, wherein the instructions comprise JavaScript.

5. The method of claim 1, wherein the authorization information associated with the user comprises a username and a password for the authorization scheme provided by the second server.

6. The method of claim 1, further comprising storing authorization information for different users.

7. The method of claim 1, further comprising determining the authorization scheme provided by the second computer.

8. The method of claim 7, further comprising storing information identifying the different authorization schemes used by different respective servers.

9. The method of claim 8, wherein the sending the information to the second server comprises sending the information within an HTTP (HyperText Transfer Protocol) GET or POST message.

10. The method of claim 1, wherein the network comprises at least one of the following: an intranet and the Internet.

11. The method of claim 1, wherein the network resource comprises a document.

12. The method of claim 1, further comprising sending an abstract of the network resource to the client.

13. The method of claim 12, wherein the message identifying a network resource comprises a message generated in response to user selection of the abstract.

14. A computer program product, disposed on a computer readable medium, for use in providing access to network resources, the program including instructions for causing a processor to:
receive, at a first server from a remote client, a message identifying a network resource, the message being associated with a user or group, the resource being protected by an authorization scheme provided by a second server;
determine authorization information associated with the user or the group of users; and
send the authorization information, in accordance with the authorization scheme, to the second server.

15. The program of claim 14, further comprising instructions for causing the processor to transmit instructions for processing by the client, the transmitted instructions for causing the client to transmit the authorization information to the second server.

16. The program of claim 15, further comprising instructions for causing the processor to determine that the authorization information sent to the second server by the first server results in authorization.

17. The program of claim 15, wherein the transmitted instructions comprise JavaScript.

18. The program of claim 14, wherein the authorization information associated with the user comprises a username and a password for the authorization scheme provided by the second server.

19. The program of claim 14, further comprising instructions for causing the processor to store authorization information for different users.

20. The program of claim 14, further comprising instructions for causing the processor to determine the authorization scheme provided by the second computer.

21. The program of claim 14, further comprising instructions for causing the processor to store information identifying the different authorization schemes used by different respective servers.

22. The program of claim 14, wherein the instructions for causing the processor to send the information to the second server comprise instructions that cause the processor to send the information within an HTTP (HyperText Transfer Protocol) GET or HTTP POST message.

23. A method for authorizing a user attempting to access a document over the Internet, the method comprising:
storing authorization information for different users;
storing information identifying the different authorization schemes used by different respective servers;
sending an abstract of a document to a web browser client;
receiving, at a first server from the web browser client, a message identifying the document, the message being associated with the user, the document being protected by an authorization scheme provided by a second server;
determining authorization information associated with the user, the authorization information including a username and a password;
determining the authorization scheme provided by the second server;
sending the authorization information, in accordance with the authentication scheme, to the second server;
determining that the authorization information sent to the second server successfully authorized access; and
transmitting instructions to the client, the instructions for causing the client to transmit the authorization information to the second server.

24. A system for providing access to network resources served by different network servers, the system comprising:
storage configured to store authorization information for different servers and/or resources for different users and/or groups of users; and
instructions for causing a system processor to
receive, at a first server from a remote client, a message identifying a network resource, the message being associated with a user or group of users, the resource being protected by an authorization scheme provided by a second server;
determine authorization information associated with the user or the group of users from the storage of authorization information; and
send the authorization information, in accordance with the authorization scheme, to the second server.

26. A method for use in providing access to network resources, the method comprising:
receiving, at a first server from a remote client, a message identifying a network resource, the message being associated with a user or group of users, the resource being protected by an authorization scheme provided by a second server;
determining authorization information associated with the user or the group of users; and
transmitting instructions for processing by the client, the instructions for causing the client to transmit the authorization information to the second server.

27. The method of claim 26, further comprising sending the authorization information, in accordance with the authorization scheme, to the second server.

28. The method of claim 26, wherein the instructions comprise JavaScript.

29. The method of claim 26, wherein the authorization information associated with the user comprises a username and a password for the authorization scheme provided by the second server.

30. The method of claim 26, further comprising storing authorization information for different users.

31. The method of claim 26, further comprising determining the authorization scheme provided by the second computer.

32. The method of claim 31, further comprising storing information identifying the different authorization schemes used by different respective servers.
